(19) United States
(12) Patent Application Publication
(10) Pub. No.: US 2026/0091819 A1
(43) Pub. Date: Apr. 2, 2026

(54) Smart Cart System for Monitoring Items in a Shopping Cart

(71) Applicant: Zebra Technologies Corporation, Lincolnshire, IL (US)

(72) Inventors: Darran Michael Handshaw, Sound Beach, NY (US); Edward Barkan, Miller Place, NY (US); Igor Vinogradov, Oakdale, NY (US); Mark Drzymala, Saint James, NY (US)

(21) Appl. No.: 18/900,453

(22) Filed: Sep. 27, 2024

(51) Int. Cl. B62B 5/00; H04N 23/51; H04N 23/54; H04N 23/695

(52) U.S. Cl. CPC B62B 5/0096; H04N 23/51; H04N 23/54; H04N 23/695

(57) ABSTRACT

A modular system for monitoring items in a shopping cart is disclosed. The system includes a vision-based data capture device mounted on an articulating arm, providing a downward-facing field of view (FOV) that covers the entire interior of the cart. The system enables real-time scanning of barcodes and identification of non-coded items using object recognition and depth sensing. A detachable electronic enclosure allows for easy maintenance and charging. The system can communicate wirelessly with customer mobile devices and store networks to provide a seamless shopping experience.

### BACKGROUND OF THE DISCLOSURE

The adoption of smart shopping carts equipped with scanning and monitoring technologies has increased rapidly in retail environments. These systems automate the process of identifying items placed within the cart, often using cameras, barcode scanners, or other sensors, allowing customers to avoid traditional checkout lanes.

However, current smart cart solutions have various drawbacks. Blind spots: vision systems positioned along the rim of the cart may fail to capture images of items placed near the bottom of the basket or those stacked under other products. Bulky designs: many smart cart systems are bulky and obstruct essential cart functions, such as child seats or basket space. Additionally, they complicate cart storage by interfering with nesting. Theft vulnerability: expensive electronics attached to the cart can be easily removed or stolen if proper theft prevention measures are not implemented.

Furthermore, many existing systems require proprietary carts, making them costly and less adaptable for retailers.

The present disclosure seeks to address these limitations by providing a modular system that attaches to conventional carts, ensuring comprehensive item monitoring, improved theft prevention, and compatibility with existing store infrastructure. This system also allows for easy maintenance and modular upgrades.

### SUMMARY

In an embodiment, the system of the present disclosure includes a modular smart cart system that can be attached to a conventional shopping cart. The system comprises a mounting arm configured to be attached to the side support structure of the shopping cart. The mounting arm is an articulating arm that can be adjusted or retracted, allowing for flexible positioning of the system relative to the cart.

In a variation of this embodiment, the system further includes a support structure extending from the mounting arm, which elevates a vision-based data capture device above the shopping cart. The vision-based device is configured to have a downward-facing field of view (FOV) that enables it to observe at least the majority of the cart's interior, including the bottom of the basket, thus reducing any potential blind spots within the cart.

In another variation, the vision-based data capture device includes a first imaging assembly optimized for barcode scanning and indicia decoding, and a second imaging assembly responsible for object recognition. The system uses machine learning algorithms and may include a depth-sensing module to enhance the detection of stacked or partially hidden items.

In yet another variation, the vision-based data capture device is housed within a detachable electronic enclosure, which allows for easy maintenance and recharging. The enclosure may include wireless charging connectors for inductive charging and may also feature solar panels to harvest power from ambient light, ensuring extended operation during shopping hours.

In a further variation, the system may include a touchscreen display module mounted near the handlebar or another accessible part of the cart. This display provides real-time feedback on scanned items, their prices, and the customer's total purchase amount. In some embodiments, the display may also support voice commands to allow customers to interact with the system hands-free.

In an additional variation, the system is equipped with an anti-theft mechanism that prevents the shopping cart from leaving the store premises without completing checkout. The anti-theft mechanism may incorporate RFID tags or geo-fencing technology. If the cart attempts to leave a predefined boundary without proper checkout, the system triggers a cart-locking mechanism to prevent further movement and alerts store personnel.

In a further variation, the articulating arm of the system may include telescoping segments to allow for vertical and horizontal adjustments. This feature enables the vision-based data capture device to optimize its field of view based on the cart's load or customer preferences. The system can adjust the position of the vision-based device to ensure complete visibility and accurate scanning of all items within the cart.

In yet another variation, the system may include a temperature-sensing module integrated into the vision-based data capture device to monitor the temperature of items placed within the cart. This is particularly useful for temperature-sensitive products, such as frozen or refrigerated goods. The system can alert the customer or store personnel to ensure proper handling of these products during checkout.

In another variation, the system is configured to wirelessly communicate with external devices, such as smartphones, store networks, or cloud-based storage systems. This allows for real-time synchronization of scanned items with the store's inventory database and enables customer interaction through a mobile app, which can display a running total, store promotions, and checkout options.

In a final variation, the system further includes a real-time alert system that notifies store personnel if an unscanned or improperly scanned item is detected leaving the cart. The system may generate an audio-visual alert or automatically flag the item for further review.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed examples, and explain various principles and advantages of those embodiments.

FIG. 1 illustrates a front perspective view of the smart cart system mounted on a shopping cart, showing the articulating arm and vision-based data capture device in accordance with an embodiment of the present disclosure.

FIG. 2 illustrates a rear perspective view of the smart cart system mounted on a front of the shopping cart, showing the articulating arm in two different positions in accordance with an embodiment of the present disclosure.

FIG. 3 illustrates side view of the shopping cart system illustrating the downward-facing field of view (FOV) of the vision-based device covering the interior of the cart in accordance with an embodiment of the present disclosure.

FIG. 4 illustrates an alternate embodiment of the shopping cart system utilizing a vision-based data capture device having multiple imaging assemblies.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present disclosure provides a modular smart cart system that can be attached to conventional shopping carts. The system is designed to monitor items placed within the cart using a vision-based data capture device, which is mounted on an articulating arm. The system also includes features for theft prevention, customer interaction, and enhanced scanning accuracy through object recognition and depth-sensing technology.

### System Overview

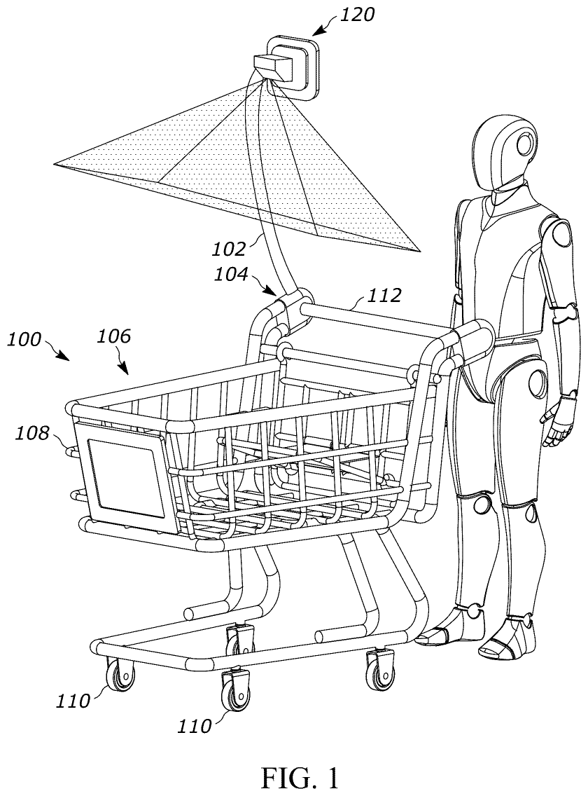

FIG. 1 depicts a shopping cart 100 with the smart cart system attached. The shopping cart includes a basket 108, wheels 110, and a handlebar 112. The system comprises an articulating arm 102, which supports the vision-based data capture device 120. The articulating arm is attached to the side frame 104 of the cart, though in some embodiments, the arm may extend from the front section 106.

The articulating arm 102 may be made from high-strength aluminum, reinforced composites, or any other suitable material providing a balance of durability and lightweight functionality. The mounting structure may include a shock-absorbing mechanism that can minimizes vibrations caused by cart movement. This ensures that the vision system remains stable during scanning, improving the accuracy of barcode detection and object recognition. Additionally or alternatively, the vision system may include hardware based or software based image stabilization mechanisms to compensate for vibration that may be experienced by the device.

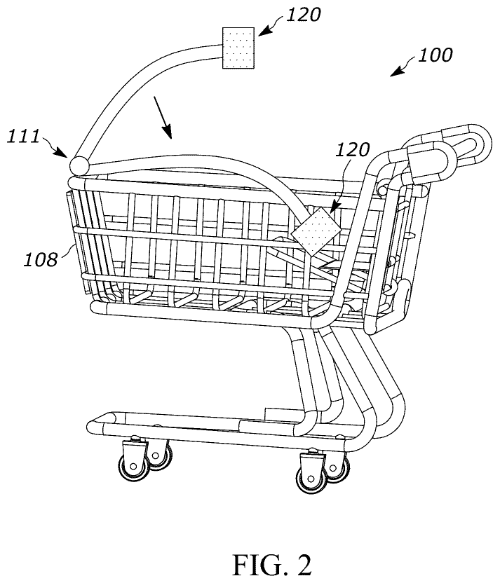

In some embodiments, the articulating arm is equipped with spring-loaded hinges 111 that allow it to fold down when the cart is nested with others for storage, as shown in FIG. 2. This ensures that the system does not interfere with the cart's ability to stack with carts as may be customarily done in various venues.

### Vision-Based Data Capture Device

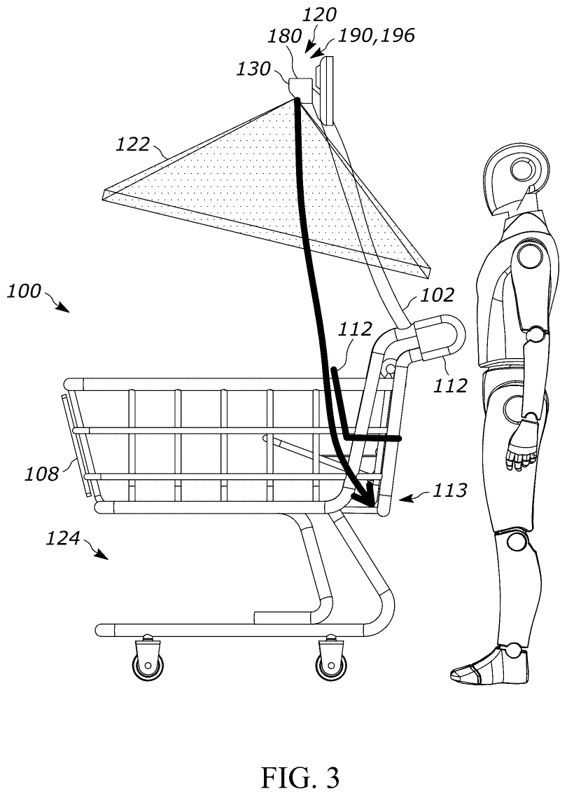

The vision-based data capture device 120, as shown, for example, in FIG. 3, is mounted on the support structure 130 at the end of the articulating arm. The field of view (FOV) 122 is directed downward, ensuring full coverage of the cart's interior, including the bottom of the basket 124. The system may use wide-angle lenses to reduce/eliminate blind spots and help ensure that no items within the cart are missed. In some embodiments, the data capture device 120 is positioned sufficiently forward relative to the cart such that its FOV has a line of sight to a rear corner 113 of the basket 108 despite an obstruction like a child seat 115.

In some embodiments the vision-based device may include two imaging assemblies. The first imaging assembly 152 may be optimized for barcode scanning and other indicia decoding tasks. This assembly may use either a color or a monochrome imaging sensor to capture image data that is then transmitted to a host for indicia decoding processes. The optimization for indicia decoding may include particular tuning of the gain and exposure to capture images of sufficient quality such that the decoder module, incorporated into the device 120, can effectively decode indicia present therein.

The second imaging assembly 154 may be optimized for capturing image data that is then transmitted to a host for a variety of imaging tasks like, for example, object recognition, object tracking, depth sensing, etc. It should be appreciated that while the FOV 122 of the first imaging assembly 152 and the FOV 155 of the second imaging assembly 154 may be different, they may also be substantially similar and the representative configuration of the FOVs 122 and 155 as shown in the figures is only exemplary. As such, the FOV 155 may extend over the entire cart 100 in a manner that is similar to that of the FOV 122 and FOV 122 may also be altered (e.g., reduced) for various applications. The optimization of the second imaging assembly for vision analysis tasks may include particular tuning of the gain and exposure to capture images of sufficient quality such that the vision processes, incorporated into the device 120 or on a separate host, can effectively perform vision tasks as needed.

Either of the first or second imaging assemblies may incorporate, or the imaging device 120 may further include a depth-sensing module 160 that provides additional detection of items in the cart. Using time-of-flight sensors or stereoscopic imaging, the depth-sensing module can create a 3D map of the cart's contents, helping ensure that all items are scanned, even if they are partially obscured by other products.

In some embodiment, the vision tasks employ machine learning techniques to identify items. The device can employ a system that is trained on a neural network that is regularly updated with new product data, allowing it to recognize a wide range of items across different categories. The object recognition system may also cross-reference recognized items with the store's inventory database, ensuring correct identification and pricing.

### Detachable Electronic Enclosure

In some embodiments, the device 120 includes a detachable electronic enclosure 180, which houses the vision-based data capture device 120, the battery 190, and the communication hardware 196. In some embodiments the enclosure is designed to be easily removed from the articulating arm 102 for maintenance or charging. In other embodiments it may include fastening hardware that can be engaged/disengaged only by appropriate individuals like venue employees, helping prevent theft or loss of the device 120.

In some configurations, the enclosure is equipped with wireless charging components, allowing the system to recharge through inductive charging stations in the cart storage area. In other instances, the device 120 may be disconnected from arm 102 and placed in a separate cradle, or otherwise connected to a power source, for charging. Once the device is sufficiently charged, it may be reattached to the arm 102 for further use.

### Customer Interaction and Display Module

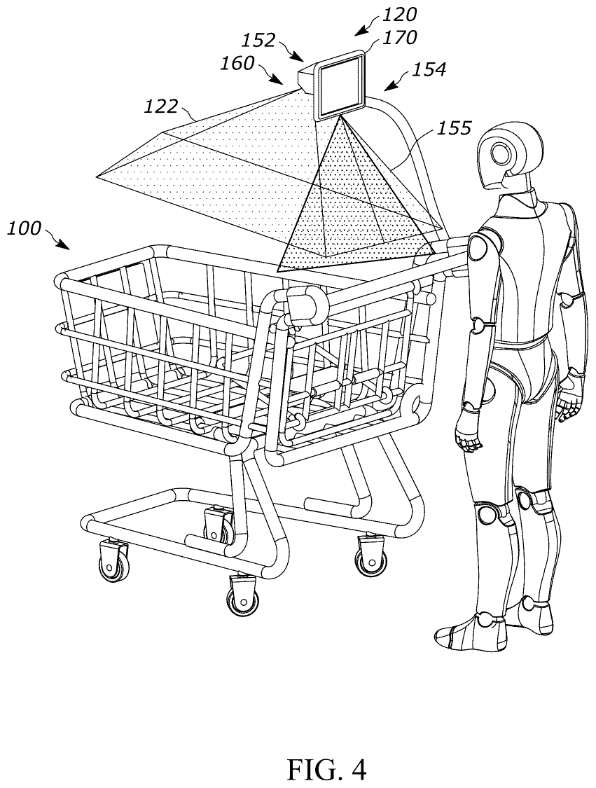

The system may include a touchscreen display module 170, as illustrated in FIG. 4. This display may be mounted to the support structure 130, making it either a separate part or an integral part of the device 120. When the display module 170 is provided as a separate detachable unit, it is preferable to have some type of communication between it and the rest of the device 120. This may be achieved via wired contacts like contacts pads, pogo pins, or other connectors suitable for frequent connection/disconnection or via wireless communication. The display module can provide real-time feedback on scanned items, prices, inventory, and other features. In some embodiments, the display includes a voice assistant, allowing customers to interact with the system through voice commands.

The display may also connect to a customer's mobile device via Bluetooth, Wi-Fi, or other suitable protocol. Receiving data from the module 170 at a mobile app can an allow the customer to track their purchases, receive promotions, and complete payment without going through a traditional checkout line.

### Telescoping Arm and Adjustability

The articulating arm 102 may feature telescoping segment(s) which allow the vision-based device to be raised or lowered to suit the cart's load. This adjustable height configuration ensures that the camera's field of view remains unobstructed, even when the cart is filled with tall items. The telescoping arm can also be rotated or tilted, allowing for optimal camera angles regardless of the cart's configuration.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory), and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

1. A system attachable to a shopping cart comprising:
a mounting arm configured to be attached to a side support structure of the shopping cart, the mounting arm being an articulating arm relative to the shopping cart, the articulating arm having a first end pivotally attached to the side support structure and an opposite second end configured to move in an arcuate path relative to the side support structure in a substantially vertical plane;
a support structure extending from the mounting arm above the shopping cart; and
a vision-based data capture device supported by the support structure, wherein the vision-based data capture device is configured to have a downward-facing field of view (FOV) directed to observe at least a majority of an interior volume of the shopping cart.

2. The system of claim 1, wherein the vision-based data capture device is housed within a detachable electronic enclosure.

3. The system of claim 1, wherein the mounting arm includes a spring-loaded mechanism allowing it to retract when the shopping cart is nested with other carts.

4. The system of claim 1, wherein the vision-based data capture device includes an object recognition module configured to identify non-coded items placed within the cart.

5. The system of claim 1, further comprising a battery configured to power the vision-based data capture device, the battery being rechargeable through wireless induction.

6. The system of claim 1, wherein the vision-based data capture device further comprises a depth-sensing module for determining the relative height and positioning of stacked items.

7. The system of claim 1, further comprising a touchscreen display integrated with the vision-based data capture device for customer interaction.

8. The system of claim 1, further comprising a real-time alert system for notifying store personnel if an unscanned item is detected leaving the cart.

9. The system of claim 1, further comprising an anti-theft mechanism that locks the wheels of the cart if it exits a designated area without completing a checkout.

10. The system of claim 1, further comprising a wireless communication module configured to transmit data to a mobile app or store network in real-time.

11. The system of claim 1, wherein the articulating arm includes a shock-absorbing mechanism to minimize vibrations from cart movement.

12. The system of claim 1, wherein the vision-based data capture device includes a multi-lens system for capturing images from different angles to improve object recognition.

13. The system of claim 1, further comprising a temperature-sensing module integrated into the vision-based data capture device for monitoring the temperature of items placed within the cart.

14. The system of claim 1, wherein the telescoping segments of the articulating arm allow for vertical and horizontal adjustments to optimize the field of view based on cart load and configuration.

15. The system of claim 1, wherein the display module further includes a voice assistant for providing auditory feedback and interacting with customers through voice commands.

16. The system of claim 1, wherein the electronic enclosure includes a modular battery pack that can be replaced without removing the entire enclosure from the cart.

17. The system of claim 1, wherein the anti-theft mechanism comprises a geo-fencing system that triggers a cart-locking system if the cart crosses a virtual boundary without completing checkout.

18. The system of claim 1, wherein the communication module is configured to connect to cloud-based storage for real-time synchronization with store inventory systems.

19. The system of claim 1, wherein the vision-based data capture device further comprises a barcode scanning module that adjusts focus and orientation based on the position of the scanned item.

20. The system of claim 1, wherein the thermal imaging module detects temperature-sensitive items and provides notifications to the user for handling such items during the checkout process.
